(19) United States
(12) Patent Application Publication
(10) Pub. No.: US 2006/0114515 A1
(43) Pub. Date: Jun. 1, 2006

(54) Encryption and decryption method for scanned data

(75) Inventor: Yang-Moon Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/029,352

(22) Filed: Jan. 6, 2005

(30) Foreign Application Priority Data
Jan. 20, 2004 (KR) 2004-4156

(51) Int. Cl. H04N 1/40

(52) U.S. Cl. 358/3.28

(57) ABSTRACT

An encryption method for scanned data in a scan system comprised of a scanner for scanning a document, and a host for displaying scanned data of the document on a display device. The method includes the steps of converting a scanned image from the scanner into data having a designated data format, and transmitting the scanned data to the host. The method further comprises steps of processing each pixel value comprising the transmitted scanned data with a pre-processed pixel value. Accordingly, the driver for driving the scanner ensures that the scanned data (such as, a document) is not displayed on a monitor during the scanning process, thereby maintaining the security of the document.

### CROSS-REFERENCE TO RELATED APPLICATIONS

This application claims the benefit under 35 U.S.C. §119 of Korean Patent Application No. 2004-4156 filed in the Korean Intellectual Property Office on Jan. 20, 2004, the entire contents of which are hereby incorporated by reference.

### BACKGROUND OF THE INVENTION

1. Field of the Invention

The present invention relates in general to an encryption and decryption method for scanned data. More specifically, the present invention relates to an encryption method for preventing the scanned data from being displayed on a monitor.

2. Description of the Related Art

In general, a scanner scans a document, converts the document into a TIF, BMP, or JPEG format image or the like, and then sends the image to a host computer. Anyone can then see the scanned output through a display device (that is, a monitor) of the host computer, and it does not matter whether the scanned document is highly confidential. An attempt has been made for ensuring the security of the scanned data by requesting a computer user input a password of the scanned data when the host computer loads the data. However, this security method works only for the scanned data stored in the host computer. Another drawback of this method is that a third person could still see the scanned output through the monitor when the confidential document is being scanned.

There is still another technique for protecting data from public disclosure by requesting a computer user input a password to a driver program installed on the host computer and thereby, limiting the scanner driving. However, this method also fails to prevent the confidential document from being displayed on the monitor during the scanning process.

Accordingly, a need exists for a method to secure data, and specifically, a need exists for a method to prevent the display of a scanned output on a monitor during the scanning process.

### SUMMARY OF THE INVENTION

It is, therefore, an aspect of the present invention to provide an encryption and decryption method for scanned data, whereby the scanned output cannot be displayed on a monitor during the scanning process.

To achieve the above and other aspects and advantages, an encryption method is provided for scanned data in a scan system comprised of a scanner for scanning a document, and a host for displaying scanned data of the document on a display device. The method includes the steps of converting a scanned image from the scanner into data having a designated data format, and transmitting the scanned data to the host. The method further comprises steps of then processing each pixel value comprising the transmitted scanned data with a pre-processed pixel value.

The processing step includes the sub-step of including in the scanned data, information regarding an addition or subtraction of the pixel value of the scanned data and the pre-processed pixel value.

At the processing step, the pixel value of the scanned data is compared with the pre-processed pixel value, and if the addition of the pixel value and the pre-processed pixel value exceeds an upper limit of the pixel value, the pre-processed pixel value is subtracted from the pixel value and information thereon is added in the scanned data.

At the processing step, the pixel value of the scanned data is compared with the pre-processed pixel value, and if the addition of the pixel value and the pre-processed pixel value does not exceed an upper limit of the pixel value, the pre-processed pixel value is added to the pixel value and information thereon is added in the scanned data.

The processing step is performed on an RGB value of each pixel value of the scanned data and on an RGB value of the pre-processing pixel value, respectively.

At the processing step, information regarding an addition or subtraction of the RGB values of the pixel value of the scanned data and the pre-processed pixel value is added in each RGB value.

The display device displays a process output of the pixel value of the scanned data and the pre-processed pixel value.

The transmitting step includes the sub-steps of driving a driver for the scanner, inputting a password for driving the driver, and driving the scanner and transmitting to the host the image from the scanner if the input password is correct.

Another aspect of the present invention is to provide a decryption method for scanned data including information about a process method of encrypted scanned data, wherein an encryption is performed by processing each pixel value comprising the scanned data transmitted from a scanner with a pre-processed pixel value. The method further includes the steps of determining a process method of the encrypted scanned data and the pre-processed pixel value on the basis of the information, and the steps of restoring each pixel value comprising the encrypted scanned data by utilizing the pre-processed pixel value according to the decision result.

The included information is regarding the addition or subtraction of the pixel value of the scanned data and the pre-processed pixel value.

The restoring step is performed on an RGB value of the encrypted scanned data and an RGB value of the pre-processed pixel value, respectively.

The restoring step also includes the sub-steps of driving a driver for the scanner, inputting a password for driving the driver, and restoring the scanned data if the input password is correct.

### BRIEF DESCRIPTION OF THE DRAWINGS

The above aspects and features of the present invention will become more apparent by describing certain embodiments of the present invention with reference to the accompanying drawings, in which:

FIG. 1 is a conceptual block diagram illustrating an encryption method for scanned data according to an embodiment of the present invention;

FIG. 2A and FIG. 2B are conceptual diagrams illustrating an encryption and decryption method according to an embodiment of the present invention;

FIG. 3 illustrates a file structure for scanned data according to an embodiment of the present invention;

FIG. 4 is a flowchart of an encryption method for scanned data according to an embodiment of the present invention; and

FIG. 5 is a flowchart of a decryption method for encrypted data of FIG. 4 according to an embodiment of the present invention.

Throughout the drawings, like reference numerals will be understood to refer to like parts, components and structures.

### DETAILED DESCRIPTION OF EXEMPLARY EMBODIMENTS

An exemplary embodiment of the present invention will be described in greater detail below with reference to the accompanying drawings.

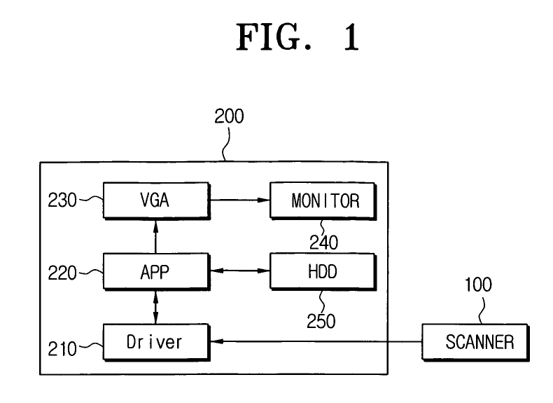

FIG. 1 is a conceptual diagram for describing an encryption method for scanned data according to an embodiment of the present invention.

As shown in FIG. 1, scanned data is transmitted from a scanner 100 to a host computer 200. A driver 210, which is installed in the host computer 200 for driving the scanner 100, adds or subtracts an RGB (red, green, blue) pixel value to encrypt the scanned data, and then provides the encrypted scanned data to an application program (APP) 220. The APP 220 applies the encrypted scanned data in the driver 210 to a monitor 240 by means of a VGA (Video Graphic Adapter) 230, and the monitor 240 displays the encrypted image.

When the scanner 100 scans the document, only the encrypted image of the document is displayed on the monitor 240. Thus, other people can no longer determine the contents of the scanned data. To reproduce the encrypted data on the monitor 240 in a hard disk drive (HDD) 250, the scanned data file is deciphered or decrypted in the driver 210. The decryption is accomplished by removing the pre-processed pixel value added to or subtracted from, the RGB value comprising the scanned data.

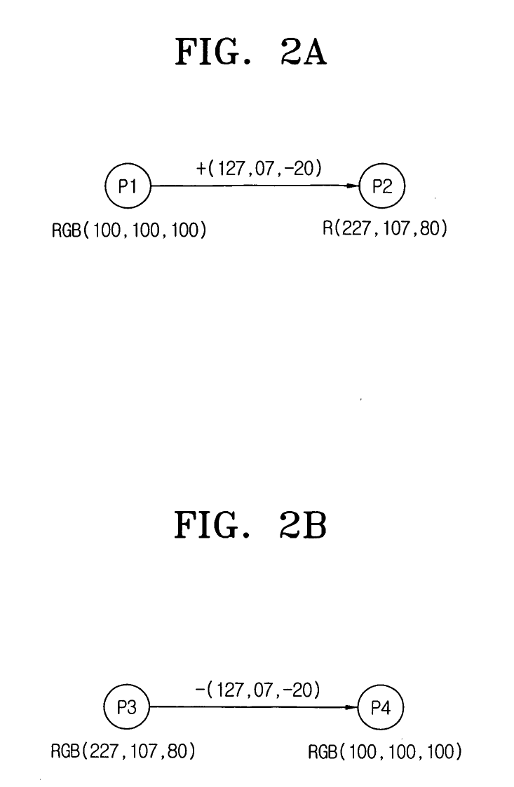

FIG. 2A and FIG. 2B are conceptual diagrams of an encryption and decryption method according to an embodiment of the present invention.

FIG. 2A is a conceptual diagram of an encryption method for scanned data according to an embodiment of the present invention. In FIG. 2A, a pixel P1 represents one of many pixels comprising the scanned data which the scanner 100 has read. If, in the example shown in FIG. 2A, the RGB value of the pixel P1 is (100, 100, 100), and a combined RGB value of the pixel built in the driver 210 for the encryption of the pixel value is (127, 07, −20), respectively, then the pixel value of the pixel P1 becomes (227, 107, 80). Therefore, the pixel value of each pixel (such as, P1) comprising the scan data is changed, and when reproducing the data on the monitor 240 through the VGA 230, the displayed image appears abnormal and unrecognizable. This makes it possible to protect the document during scanning. Although only one pixel P1 out of the many pixels comprising the scanned data is illustrated in FIG. 2A, in practice, the encryption method of the present embodiment is applied to every pixel of the scanned data.

The RGB value of each pixel P1 is in a range of 0-255. In the case where the sum of the RGB value of the pixel P1 and the pre-processed pixel value (127, 07, −20) exceeds 255, an encryption of the RGB value of the pixel P1 can not be performed by addition. For example, when the RGB value of the pixel P1 is (200, 200, 200), and the pre-processed pixel value is (127, 07, −20), the RGB value of the pixel P1 cannot be encrypted because the sum thereof exceeds 255. In this case, the encryption of the RGB value of the pixel P1 can be accomplished by subtracting, instead of adding, the pre-processed pixel value (127, 07, −20) from the RGB value of the pixel P1. The obtained RGB value of the encrypted pixel P1 is then (73, 207, 220). The encryption method for the scanned data according to an exemplary embodiment of the present invention, therefore, requires an identifier for determining whether the encryption for each pixel should be performed through addition or subtraction. Also, by granting the identifier to each pixel or a scanned data file (the aggregation of every pixel), the encrypted scanned data can be decrypted.

FIG. 2B is a conceptual diagram illustrating a decryption method for the encrypted scanned data of FIG. 2A.

As shown in FIG. 2B, the decryption is accomplished by obtaining a difference between the RGB value (227, 107, 80) of an encrypted pixel P3 and a pre-processed pixel value, in the driver 210. The difference between the RGB value of the encrypted pixel P3 and the pre-processed pixel value equals an original RGB pixel value (100, 100, 100), as scanned by the scanner 100. In the case where the pixel value of the pixel P3 corresponds to a pixel value generated by subtraction between the RGB value of the pixel P3 and the pre-processed pixel value, the pre-processed pixel value (127, 107, −20) is added to the pixel value of the pixel P3 to restore the original pixel value.

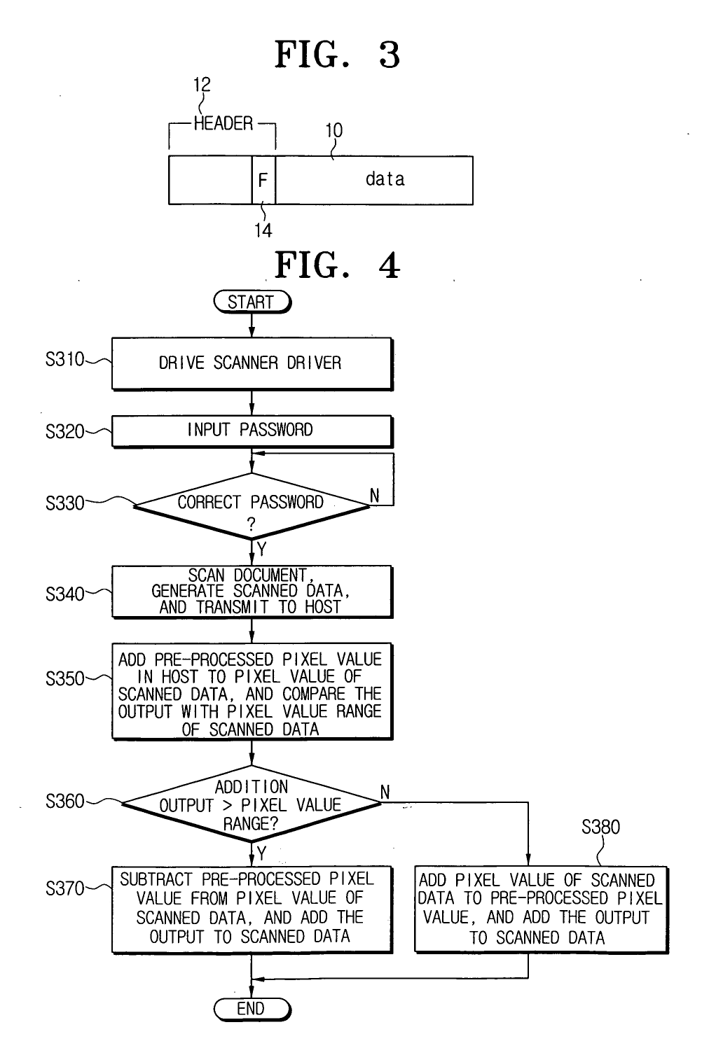

FIG. 3 illustrates a file structure for the scanned data. The file structure includes a data (area) 10 where the scanned data is located, and a header 12 including file information, such as a file format of the scanned data, a file size, and a file creation date. In the encryption method according to an embodiment of the present invention, the header 12 further includes an encryption method 14 called a flag F, which indicates on which basis the encryption of each pixel has been performed, that is, by either the addition or subtraction of a pre-processed pixel value in the driver 210 and each pixel stored in the data. The flag F can have a value of 0 or 1. An arrangement can be made with the driver 210 to designate the value “0” to indicate the addition method, and the value “1” to indicate the subtraction method. If each pixel comprising the scanned data is encrypted using the same method, one flag can be included instead of a plurality of flags. Hence, the driver 210 determines the encryption method by referring to the header of the file, and decrypts the encrypted scanned data in accordance with the decision result.

FIG. 4 is a flowchart illustrating an encryption method for scanned data according to an embodiment of the present invention.

First, a user turns on the scanner 100 to drive the driver 210 installed in the hard disk drive (HDD) 250 of the host computer 200 at step S310. When it is ready, the driver 210 displays on the monitor 240 a password input window for identifying a correct user of the scanner 100. The user then inputs a password to the password input window at step S320. If the user inputs a correct password to the displayed password window as determined at step S330, the user is permitted to use the scanner 100. Thus, the user can place a document in the scanner 100 that scans the document, generates scanned data, and transmits the scanned data output to the host computer 200 at step S340.

Next, the driver 210 encrypts the scanned data according to an RGB value of each pixel comprising the scanned data. The encryption of the scanned data is accomplished by adding or subtracting the pre-processed pixel value in the driver 210 to or from the RGB value of each pixel. At this point, the decision whether to add or subtract the pre-processed pixel value to or from the RGB value of each pixel is determined by comparing the sum of the RGB value of each pixel and the pre-processed pixel value, with the upper limit of the RGB value at step S350. For example, if the sum exceeds the upper limit of the RGB value range (0-255) at step S360, the pre-processed pixel value is subtracted from the RGB value of each pixel comprising the scanned data at step S370. But if not, the pre-processed pixel value is added to the RGB value of each pixel at step S380.

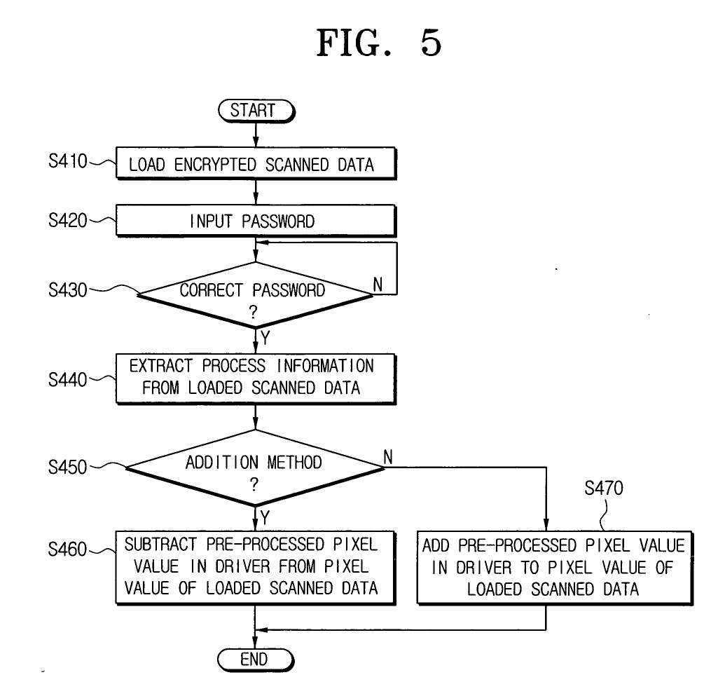

FIG. 5 is a flowchart illustrating a decryption method for the encrypted data of FIG. 4 according to an embodiment of the present invention.

First, the APP 220 loads the encrypted scanned data from the HDD 250 at step S410. The driver 210 then displays on the monitor 240 a password input window for identifying a correct user of the scanner 100. The user then inputs a password to the password input window at step S420. If the input password is correct as determined at step S430, the APP 220 extracts processed information from the loaded scanned data file at step S440. The processed information indicates on which basis (addition or subtraction method) that the scanned data has been encrypted. This can be done by deciphering the information added in the header of the scanned data file as described above with reference to FIG. 3.

If the extracted processed information appears to be obtained from the addition method as determined at step S450, the driver 210 subtracts the pre-processed pixel value from the RGB value of the loaded scanned data, and applies it to the APP 220 at step S460. In like manner, if the extracted processed information appears to be obtained from the subtraction method as determined at step S450, the driver 210 adds the pre-processed pixel value to the RGB value of the loaded scanned data, and applies it to the APP 220 at step S470. The addition of the RGB value of the scanned data and the pre-processed pixel value then becomes an original image that the scanner 100 has scanned, and the user is able to see this image on the monitor 240.

As described above, the driver for driving the scanner ensures that the scanned data is not displayed on the monitor during the scanning process. In this manner, the security of a confidential document can be maintained during the scanning process.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An encryption method for scanned data in a scan system having a scanner for scanning a document, and a host for displaying scanned data of the document on a display device, the method comprising the steps of:
converting an image scanned from the scanner into data having a designated data format, and transmitting the scanned data to the host; and
processing each pixel value comprising the transmitted scanned data with a pre-processed pixel value.

2. The method according to claim 1, wherein the processing step comprises the step of adding information regarding an addition or subtraction of the pixel value of the scanned data and the pre-processed pixel value in the scanned data.

3. The method according to claim 1, wherein the processing step comprises the steps of:
comparing the pixel value of the scanned data with the pre-processed pixel value, and if the addition of the pixel value and the pre-processed pixel value exceeds an upper limit of the pixel value, the pre-processed pixel value is subtracted from the pixel value and information thereon is added in the scanned data.

4. The method according to claim 2, wherein the processing step comprises the steps of:
comparing the pixel value of the scanned data with the pre-processed pixel value, and if the addition of the pixel value and the pre-processed pixel value does not exceed an upper limit of the pixel value, the pre-processed pixel value is added to the pixel value and information thereon is added in the scanned data.

5. The method according to claim 2, wherein the processing step is performed on an RGB value of each pixel value of the scanned data and an RGB value of the pre-processed pixel value, respectively.

6. The method according to claim 5, wherein the processing step further comprises the step of adding in each RGB value information regarding an addition or subtraction of the RGB values of the pixel value of the scanned data and the pre-processed pixel value.

7. The method according to claim 1, further comprising the step of displaying a process output of the pixel value of the scanned data and the pre-processed pixel value via the display device.

8. The method according to claim 1, wherein the transmitting step comprises the steps of:
driving a driver program for the scanner;
inputting a password for driving the driver program; and
driving the scanner and transmitting the image from the scanner to the host if the input password is correct.

9. A decryption method for scanned data including information about a process method of an encrypted scanned data, wherein an encryption is performed by processing each pixel value comprising the scanned data transmitted from a scanner with a pre-processed pixel value, the method comprising the steps of:
determining a process method of the encrypted scanned data and the pre-processed pixel value on the basis of the information; and
restoring each pixel value comprising the encrypted scanned data by utilizing the pre-processed pixel value according to the decision result.

10. The method according to claim 9, wherein the information comprises data regarding the addition or subtraction of the pixel value of the scanned data and the pre-processed pixel value.

11. The method according to claim 9, wherein the restoring step is performed on an RGB value of the encrypted scanned data and an RGB value of the pre-processed pixel value, respectively.

12. The method according to claim 9, wherein the restoring step comprises the steps of:
driving a driver program for the scanner;
inputting a password for driving the driver program; and
restoring the scanned data if the input password is correct.
